(19) United States
(12) Patent Application Publication
(10) Pub. No.: US 2009/0284370 A1
(43) Pub. Date: Nov. 19, 2009

(54) Property Locator System

(76) Inventor: Robert Gurman, San Francisco, CA (US)

Correspondence Address: OUR PAL ASIJA;ASIJA HOUSE, 7 WOONSOCKET AVENUE, SHELTON, CT, 06484-5536, US

(21) Appl. No.: 12/121,892

(22) Filed: May 16, 2008

(51) Int. Cl. H04Q 7/00; H04Q 7/20

(52) U.S. Cl. 340/539.13; 455/456.6

(57) ABSTRACT

Methods, devices 101, 103, and system 100 for locating and tracking stationary or moving personal property 99 comprising a concealed article unit 101 attached to the article to be tracked and a portable owner unit 103, which is programmed into the cellular phone 303 of the user or owner 102, suitable for tracking any personal property 99 including pets, children, moving vehicles etc., in myriad of circumstances but especially for tracking luggage 99 for air, rail and bus passengers 102. This invention is also known by its trademark name of EZTrak and based upon its functionality is variously known as “Luggage Locator, Theft Prevention System, Article Finder, Property Tracker, Travel Mate and the like.

### BACKGROUND

This invention relates generally to personal property. More particularly it relates to tracking and management of personal property. Even more particularly it relates to tracking and management of property and/or its owner in transit. One of the applications of this invention is luggage location and tracking for air, rail and bus travelers as the luggage arrives at the destination carousel to obviate taking of the luggage in question by a third party deliberately or unintentionally due to similarity of many travel friendly bags.

Airlines alone handle over 3 billion bags each year. An estimated 30 million bags were temporarily lost by airlines in 2005, and 200,000 of those bags were never reunited with their owners. The problem of mishandled baggage is worsening all over the world each year on both sides of the pond. In 2005 alone mishandled luggage cost world airlines $2.5 billion, compared with $1.6 billion in 2004. This invention is also known by its trademark name of EZTrak.

Based upon its purpose and functionality the invention is also variously known as known as “Luggage Locator, Theft Prevention, Article Finder, Property Tracker, Travel Mate and the like especially for trademark purposes.

### SUMMARY

This invention teaches methods, devices, and system for locating and tracking personal property especially when either is in transit. It essentially comprises a concealed article unit attached to the article to be tracked and an owner unit, which is programmed into the cellular phone of the user or owner.

It is ideally suited for tracking luggage for air, rail and bus passengers, but can be also used for tracking any personal property including pets, children, moving vehicles etc., in myriad of circumstances. The incremental cost of the system to the user is very low and it pays for itself as it prevents theft or loss of valuable personal property.

### THE PROBLEM

The problem with prior art property tracking system is that they are not practical as they require the users to carry yet another tracking device with them. The present invention permits the tracking function in the cell phone wherein the programming and the articles to be located or tracked are readily changeable. Furthermore the prior art devices are cumbersome to use. They are neither affordable nor aesthetic. In summary they are not practical because they are neither cost effective nor efficient in operation. Following are some of the problems with the prior art embodiments.
a) They entail carrying an additional unit.
b) They are not simple, cost effective, aesthetic, modular and even elegant.
c) Prior art devices are not easy to make or use.
d) They are neither cost effective nor efficient.

### PRIOR ART

A preliminary prior art patentabilty and novelty search was conducted. Furthermore the inventor is intimately familiar with the prior art. Following are typical examples of the prior art arranged in reverse chronological order for easy reference of the reader.

10) U.S. Non-Provisional Utility Pat. No. 6,975,221 B2 awarded to Joan Monck on Dec. 13, 2005 for, “Luggage Identifier for Air and Rail Travelers.

09) U.S. Non-Provisional Utility Pat. No. 6,879,264 B2 presented to Hidaka et al on Apr. 12, 2005 for, “Article Identifying System”

08) U.S. Non-Provisional Utility Pat. No. 6,788,199 B2 blessed upon Crabtree et al on Sep. 7, 2004 for, “Article Locator System”

07) U.S. Non-Provisional Utility Pat. No. 6,246,314 B1 bestowed upon Omeur Djaid on Jun. 12, 2001 for “Vehicle Locator Device”

06) U.S. Non-Provisional Utility Pat. No. 6,147,602 honorably given to Sheldon Bender on Nov. 14, 2000 for, “Luggage Locator System”

05) U.S. Non-Provisional Utility Pat. No. 6,046,307 showered upon Ronald Silver on May 16, 2000 for, “Method for Relating Information about an Article to a Finder of the Article”

04) U.S. Design Patent Des. 420,301 designed by Troy Henderson and issued on Feb. 8, 2000 for “Lost Article Locator”

03) U.S. Non-Provisional Utility Pat. No. 5,617,074 earned by Marvin White on Apr. 1, 1997 for, “Child Finder”

02) U.S. Non-Provisional Utility Pat. No. 5,570,081 invented by Stephen Holstrom and published on Oct. 29, 1996 for, “Lost Article Tracking System”

01) U.S. Non-Provisional Utility Pat. No. 4,571,492 honorably presented to Kane et al on Feb. 18, 1986 for, “Method to Detect, Identify, Authenticate and Date an Article”

### OBJECTIVES

At any rate none of the prior art devices known to the applicant or his attorney disclose the exact embodiment of this inventor that constitutes a simple, elegant, quick, convenient, affordable means for readily tracking all types of personal property in a myriad of circumstances.
01) It is an objective of this invention to provide methods, devices and systems for locating and tracking all types of personal property in myriads of circumstances.
02) Another objective of this invention is to provide means for tracking property in transit including pets, children, moving vehicles, luggage in transit etc.
03) Another objective of this invention is to provide a wireless communication interface between an article unit and an owner unit.
04) Another objective of this invention is to program the owner unit into owners cellular phone so as to obviate carrying an additional unit.
05) Another objective of this invention is to provide a simple, affordable and elegant method of tracking articles.
06) Another objective of this invention is to avoid waste of resources.
07) Another objective of this invention is to provide a means for conveniently installing and uninstalling the tracking device onto the article to be tracked in a concealed manner so that a thief cannot defeat the tracking feature.
08) Another objective of this invention is to provide a device that is made of modular components.
09) Another objective of this invention is that it can be manufactured and maintained with ease.
10) Another objective of this invention is to make it suitable for user of a broad range of ages and situations.
11) Another objective of this invention is to provide a slick and slim design to match the local decor and environment.
12) Another objective of this invention is to provide a design, which can be adapted for other applications.
13) Another objective of this invention is that its design is simple and even elegant so as to complement and enhance the environment and the structures around it.
14) Another objective of this invention is that its use is intuitive and even user transparent such that it requires no additional training.
15) Another objective of this invention is that it be capable of multiple uses.
16) Another objective of this invention is that it uses little or no additional energy.
17) Another objective of this invention is that the invention be user friendly.
18) Another objective of this invention is that it be reliable such that it practically never fails and requires little or no maintenance and has high MTBF.
19) Another objective of this invention is that it be environmentally friendly.
20) Another objective of this invention is that it be physically safe in normal environment as well as accidental situations.
21) Another objective of this invention is that it be long lasting made from durable material.
22) Another objective of this invention is that it meets all federal, state, local and other private standards guidelines, regulations and recommendations with respect to safety, environment, and energy consumption.
23) Another objective of this invention is that can be easily scaled up or down in size, cost, performance etc.,
24) Another objective of this invention is that its use is semi-automatic if not fully automatic.
25) Other objectives of this invention reside in its simplicity, elegance of design, ease of manufacture, service and use and even aesthetics as will become apparent from the following brief description of the drawings and the detailed description of the concept embodiment.

Unfortunately none of the prior art devices singly or even in combination provides all of the features established by the inventor for this system as enumerated below.
a) Safe, Secure, Simple and elegant sleek design
b) Affordable and Cost effective Long lasting and durable
c) Easy to manufacture, use and operate and maintain.
e) Automatic operation without assistance of another person.
f) User Friendly and intuitive easy to install, operate, and change in a hurry
g) Requires no additional training
h) Suitable for people of all ages and gender in all types of situations.
i) Multiple uses in a wide range of situations and circumstances.
j) Easily scaleable up and down and easily adaptable for other uses.

### BRIEF DESCRIPTION OF DRAWINGS

The unique features of the invention shall now be described in relationship to the following drawings, which are integral part of the specifications and are incorporated herein.

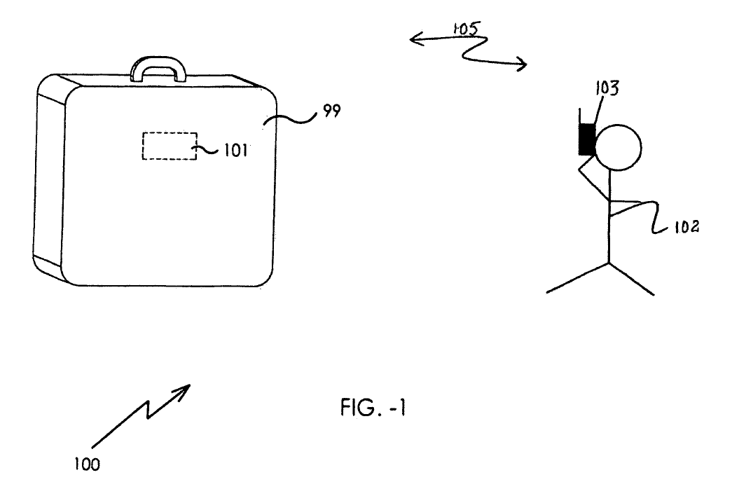

a) FIG. 1 is an isometric perspective view of an article of luggage of a traveler with owner unit integrated into a cell phone and article unit affixed on the inside.

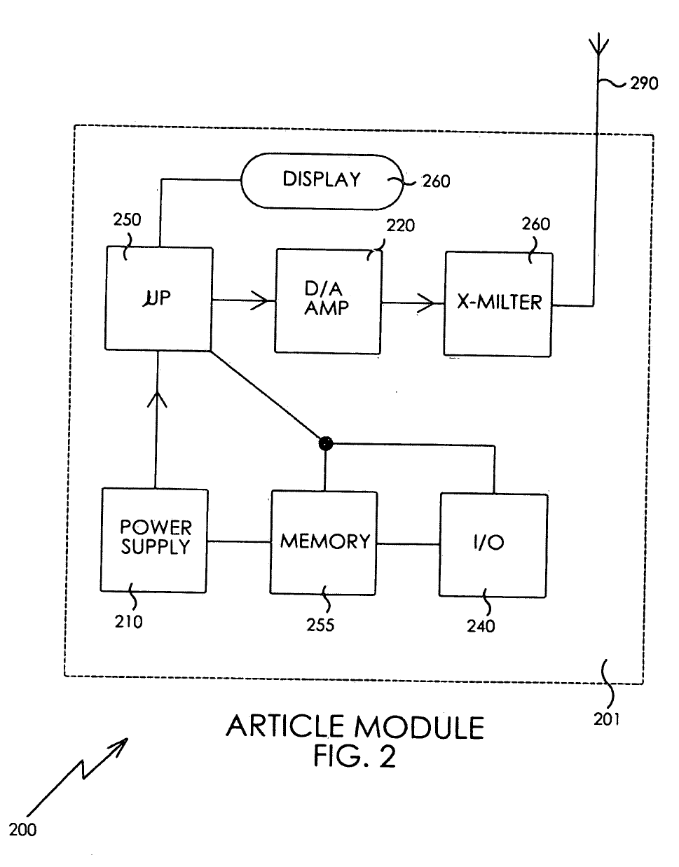

b) FIG. 2 is a block diagram of the article unit.

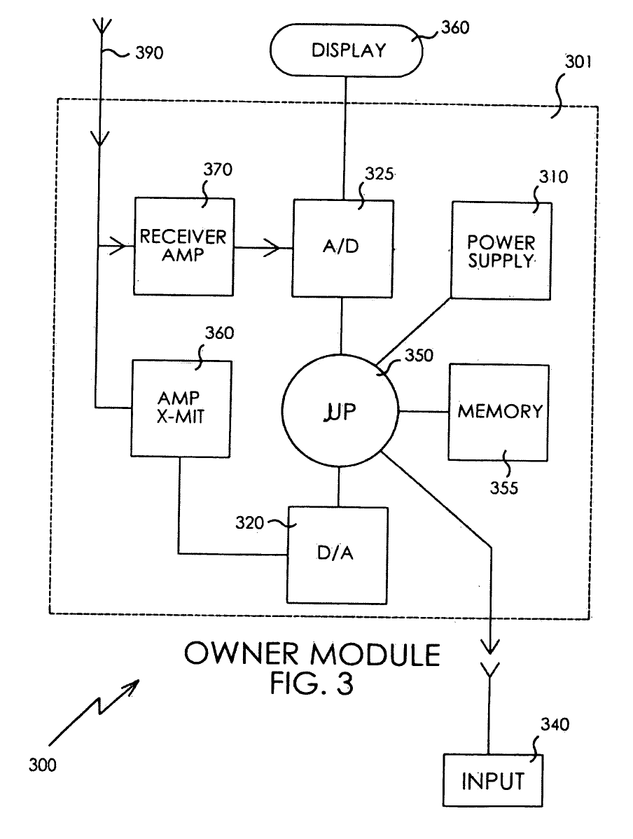

c) FIG. 3 is a block diagram of the owner's unit, which can be a cellular phone.

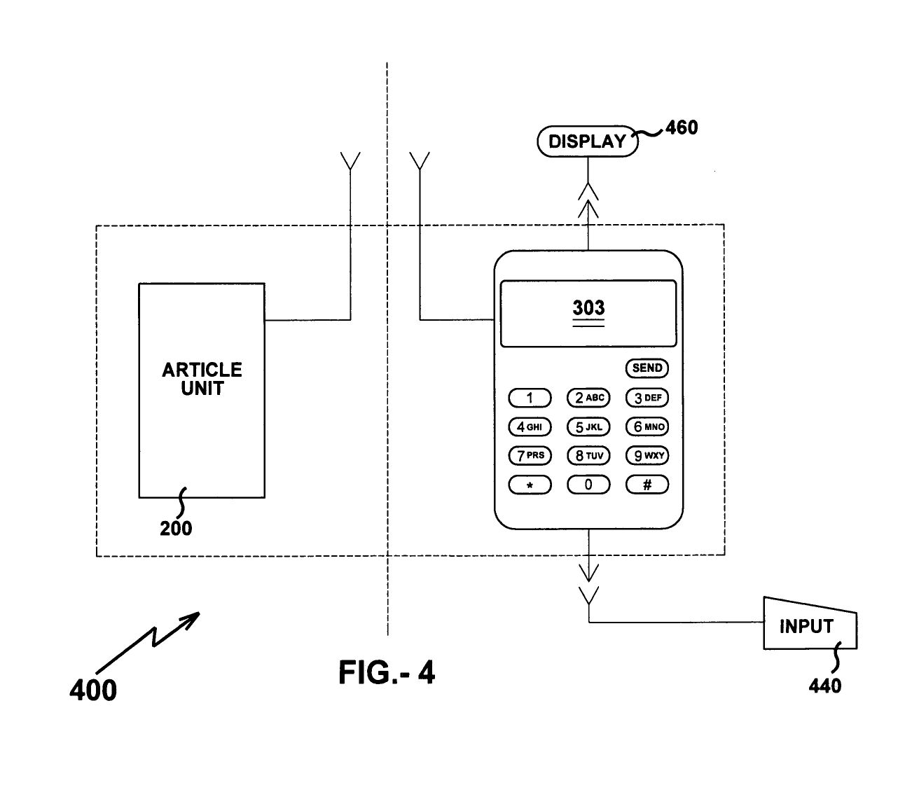

d) FIG. 4 shows the relation ship between the article unit and the owner unit, wherein the owner unit is integrated into a cell phone.

### DETAILED DESCRIPTION OF THE BEST MODE PREFERRED EMBODIMENT

As shown in the drawings wherein like numerals represent like parts throughout the several views, there is generally disclosed in FIG. 1 is an isometric perspective view of an article of luggage 99 of a traveler 102 with article unit 101 affixed on the inside. Furthermore the owner unit integrated into a cell phone 103 and article unit 101 is affixed on the inside of a suitcase 99.

FIG. 2 is a block diagram 200 of the article unit 201 complete with power supply 210, Digital to Analog Converter and amplifier 220, Input/Output 240, microprocessor 250, memory 255, display 260, amplifier transmitter 280 and antenna 290.

FIG. 3 is a block diagram 300 of the owner's unit 301 which can be a cellular phone complete with power supply 310, Digital to Analog Converter 320, Analog to Digital converter 325, Input/Output 340, microprocessor 350, memory 355, display 360, receiver amplifier 370, amplifier transmitter 380 and antenna 390.

FIG. 4 delineates the owner unit and property units in greater detail. The embodiment 400 shows the relation ship between the article unit 200 and the owner's unit 300 complete with external display 460 and external input means 440. In the preferred embodiment the owner unit 300 is integrated into a cell phone 303, 403 but the custom owner unit as delineated in FIG. 3 is just as satisfactory not withstanding cost effectiveness and efficiency and inconvenience of carrying multiple units.

### Assembly Use and Opporation

The manufacturing, assembly and use of this invention is very simple even intuitive. Nonetheless the inventor recommends the following protocol for locating and tracking personal property:
a) Attaching a tracking integrated circuit chip to the article to be tracked; and
b) Carrying an owner unit in wireless communication with said tracking integrated circuit chip.

In the best mode preferred embodiment the inventor programmed the functionality of the owner's unit into the cellular phone. Skilled artisan will be able to produce the intended invention with the most efficient dimensions of any of the embodiments contained within this description such as the I.C. chip for tracking the article or piece of luggage, programming of the owner unit into the cell phone of the property owner or user.

The inventor has given a non-limiting description of the system of this invention. Due to the simplicity and elegance of the design of this invention designing around it is difficult. Nonetheless many changes may be made to this design without deviating from the spirit of this invention. Examples of such contemplated variations include the following:
a) The shape and size, thickness and material used may be modified.
b) The color, aesthetics and materials may be enhanced or varied.
c) Additional complimentary and complementary functions and features may be added.
d) A more economical version and/or size of the device may be adapted.
e) A DIY Kit version may be employed.

Other changes such as aesthetics and substitution of newer materials as they become available, which substantially perform the same function in substantially the same manner with substantially the same result without deviating from the spirit of the invention may be made.

The following is a brief description of the nomenclature and function of the components used in the best mode preferred embodiment arranged in ascending order of reference numbers.
099=Article of (generally personal property)
100=Invention of FIG. 1 generally
101=Article unit 101 affixed on the inside of the article
102=Traveler or other user
103=Cellular phone
105=Communication link directly or via cellular network
200=Embodiment of FIG. 2 generally
201=Article unit in FIG. 2 generally
210=Power supply
220=Digital to Analog Converter and amplifier
240=Input/Output
250=Microprocessor
255=Memory 255
260=Display
280=Amplifier Transmitter
290=Antenna
300=Embodiment of FIG. 3 generally
301=Article unit in FIG. 3 generally
303=Cellular phone
310=Power supply
320=Digital to Analog Converter and amplifier
340=Input/Output
350=Microprocessor
355=Memory 255
360=Display
370=Receiver Amplifier
380=Amplifier Transmitter
390=Antenna
400=Embodiment of FIG. 4 generally
440=External input means
460=External display

### Definitions and Acronyms

A great care has been taken to use words with their conventional dictionary definitions. Following definitions are included here for clarification.
3D=Three Dimensional
AC=Alternating Current
AMP=Amplifier
A/D=Analog to Digital converter
D/A=Digital to Analog converter
DC=Direct Current
DIY=Do It Yourself
I/O=Input & Output means
Integrated=Combination of two entities to act like one
Interface=Junction between two dissimilar entities
MTBF=Mean Time Between Failures
MuP=Microprocessor
Symmetrical=Mirror image along an axis or Front and back reversible &/or Left Right reversible
X=Transmitter

While this invention has been described with reference to illustrative embodiments, this description is not intended to be construed in a limiting sense. Various modifications and combinations of the illustrative embodiments as well as other embodiments of the invention will be apparent to a person of average skill in the art upon reference to this description. It is therefore contemplated that the appended claim(s) cover any such modifications, embodiments as fall within the true scope of this invention.

1) A personal property article locator and tracking system comprising an article unit and an owner unit interfaced to said article unit with wireless communication interface.

2) The personal property article locator and tracking system of claim 1 wherein said owner unit comprises software programmed into the owner's cellular phone.

3) The personal property article locator and tracking system of claim 1 wherein said personal property is in transit.

4) The personal property article locator and tracking system of claim 3 wherein said personal property is a pet.

5) The personal property article locator and tracking system of claim 3 wherein said personal property is a moving vehicle.

6) The personal property article locator and tracking system of claim 3 wherein is luggage in transit.

7) The personal property article locator and tracking system of claim 1 wherein said personal property article is a child.

8) A method of locating and tracking personal property comprising the steps of
a) attaching a tracking integrated circuit chip to the article to be tracked; and
b) carrying an owner unit in wireless communication with said tracking integrated circuit chip.

9) The method of locating and tracking personal property of claim 8 wherein said personal property is in transit.

10) The method of locating and tracking personal property of claim 8 wherein said owner unit comprises software programmed into the owner's cellular phone.

11. An luggage locator at a destination Carousel to prevent deliberate or unintentional removal of said luggage by a non-owner unauthorized person comprising an article module, and a portable owner module wirelessly connected to said article module where in the range between the said wireless module and said article module is programmable and adjustable.

12. The Luggage locator of claim 11 wherein said article module comprises:
a) a microprocessor;
b) at least one memory connected to said microprocessor;
c) an input and output means connected to said microprocessor;
d) a display connected to said microprocessor;
e) a power supply connected to said microprocessor;
f) a digital to analog converter amplifier interfaced to said microprocessor;
g) a transmitter connected to said digital to analog converter and amplifier; and
h) an antenna connected to said transmitter.

13. The Luggage locator of claim 11 wherein said portable owner module wirelessly connected to said article module comprises:
a) a microprocessor;
b) at least one memory connected to said microprocessor;
c) a detachable input means connected to said microprocessor;
d) an analog to digital converter connected to said microprocessor;
e) a receiver amplifier connected to said analog to digital converter;
f) a display connected to said analog to digital converter;
g) a power supply connected to said microprocessor;
h) a digital to analog converter interfaced to said microprocessor;
i) a transmitter amplifier connected to said digital to analog converter and amplifier; and
j) a receiver transmitter antenna connected to said receiver amplifier and said transmitter amplifier.

14. The Luggage locator of claim 11 wherein said owner unit comprises software programmed into the owner's cellular phone.

15. The Luggage locator of claim 11 wherein said personal property wherein said luggage is in transit.
